(19) United States
(12) Patent Application Publication
(10) Pub. No.: US 2026/0362373 A1
(43) Pub. Date: Nov. 12, 2026

(54) METHODS FOR DEVICES FOR FACILITATING POSITIONING BASED ON ROUND-TRIP TIME MEASUREMENT IN A WIRELESS NETWORK

(71) Applicant: Sony Group Corporation, Tokyo (JP)

(72) Inventors: Basuki PRIYANTO, Lund (SE); Martin Warwick BEALE, Bristol (GB); Shin Horng WONG, Basingstoke (GB)

(21) Appl. No.: 19/153,535

(22) PCT Filed: Jan. 10, 2024
(86) PCT No.: PCT/EP2024/050504

§ 371 Date: Aug. 4, 2025

(30) Foreign Application Priority Data
Feb. 17, 2023 (SE) 2350182-8

(51) Int. Cl. H04W 64/00; G01S 13/76; H04W 84/06

(52) U.S. Cl. CPC H04W 64/00; G01S 13/765; H04W 84/06

(57) ABSTRACT

Method carried out in a wireless network for facilitating positioning of User Equipment, UE, based on bi-directional measurement of positioning signals, said method comprising: configuring first and second resources with mutual configuration association, wherein: a first configuration (502) is indicative of the first resources for transmission of a downlink, DL, positioning signal by at least one access node of the wireless network, a second configuration (506) is indicative of the second resources for transmission of an uplink, UL, positioning signal by the UE; transmitting (507), to the UE, positioning configuration information identifying the configuration association.

### TECHNICAL FIELD

This disclosure relates to solutions for use in a wireless network for facilitating positioning based on round-trip time measurement between a wireless device to be positioned and one or more base stations of the wireless network. Specifically, solutions are provided for improving use in a non-terrestrial network, where the base station may execute signaling from or through a non-terrestrial node such as a satellite.

### BACKGROUND

In a cellular radio communications system, wireless devices may act as mobile terminals for operation by radio communication with base stations, or access nodes, of a wireless communications network. It may be noted that the most common term for wireless devices configured to operate by wireless communication is User Equipment (UE), a term which will also be used herein going forward. The cellular communications networks may e.g. be configured and operated under the specifications provided under the 3rd Generation Partnership Project (3GPP).

Further releases of the 3GPP system specifications will provide improvements in the field of Non-Terrestrial Networks (NTN), which means access networks including satellite-based access nodes which communicate radio signals via satellites. NTN has the target to offer connectivity with global coverage. The NTN may comprise a grid of satellites serving UEs on the ground, but also aerial platforms, drones or any other type of aerial device.

When a UE is operating in an NTN, various network operations in communication with the UE may require particular attention. In particular, this relates to operations that rely on measurement of time between transmission and reception of signals between a non-terrestrial (NT) access node and a UE. For one thing, distances between the UE and the access node may be considerably larger than in a terrestrial network, resulting in long propagation time. Moreover, where the access node comprises a non-stationary satellite, the distance to the NT access node changes significantly over time. This poses challenges to, inter alia, the concept of UE positioning based on signals conveyed between the UE and one or more NT access node.

### SUMMARY

In view of the above, solutions are provided herein for facilitating UE positioning based on bi-directional measurement of positioning signals in a wireless network. The solution is defined by the terms of the independent claims, whereas various further aspects related to the solution are set out in the dependent claims and in the description below.

According to one aspect, the solution relates to a method carried out in a wireless network, said method comprising:
configuring first and second resources with mutual configuration association, wherein:
   a first configuration is indicative of the first resources for transmission of a downlink, DL, positioning signal by at least one access node of the wireless network,
   a second configuration is indicative of the second resources for transmission of an uplink, UL, positioning signals by the UE;
transmitting, to the UE, positioning configuration information identifying the configuration association.

The proposed solution is particularly usable where the access node is an NT access node but is not restricted thereto.

By configuring resources for positioning signals with mutual configuration association of resources for transmission of positioning signals in opposite directions between the UE and the access node, pairing is obtained between transmission occasions, defined by the resources, of such positioning signals. This way, transmission of such paired positioning signals can be configured to minimize inaccuracy caused by movement during signaling and measurement of round-trip time (RTT), such as movement of satellite-based NT access node.

### BRIEF DESCRIPTION OF THE DRAWINGS

Various examples and use cases of the proposed solution will be described below with reference to the accompanying drawings, in which:

FIG. 1 illustrates a wireless network including a non-terrestrial access network, in the context of which the proposed solutions may be carried out;

FIG. 2 schematically illustrates the concept of RTT determination in a wireless network;

FIG. 3 illustrates legacy transmission and measurement of positioning signals for RTT determination signaling;

FIG. 4 schematically illustrates DL and UL position signaling with an NT access node comprising a satellite, where the NT access node moves between two different locations between transmission and reception;

FIG. 5 is a flow chart of various steps included in or related to a method according to the proposed solution;

FIG. 6A schematically illustrates an NT access node useful in various examples of the proposed solution;

FIG. 6B schematically illustrates different types of NT access nodes for which the proposed solution may be used;

FIG. 7 schematically illustrates a positioning, or location, node useful in various examples of the proposed solution;

FIG. 8 schematically illustrates a UE useful in various examples of the proposed solution;

FIG. 9 schematically illustrates DL and UL position signaling with an NT access node comprising a satellite, with position signal transmission configured with mutual configuration association;

FIG. 10 schematically illustrates DL and UL position signaling with an NT access node comprising a satellite, with one example of identification of the mutual configuration association;

FIG. 11A schematically illustrates transmission and reception at different time resources configured with mutual configuration association, with configuration association configured from a UE perspective of time;

FIG. 11B schematically illustrates transmission and reception at different time resources configured with mutual configuration association, with configuration association configured from an NT access node perspective of time;

FIG. 12 schematically illustrates application of the proposed solution with respect to a single NT access nodes at repeated times;

FIG. 13A schematically illustrates DL and UL position signaling with an NT access node with repeated UL signaling, with position signal transmission configured with mutual configuration association;

FIG. 13B schematically illustrates DL and UL position signaling, similar to FIG. 13A, but with a different time offset defined by the configuration association; and

FIG. 14 shows a signaling diagram of various examples of the proposed solution.

### DETAILED DESCRIPTION

In the following description, for purposes of explanation and not limitation, details are set forth herein related to various examples. However, it will be apparent to those skilled in the art that the present invention may be practiced in other examples that depart from these specific details. In some instances, detailed descriptions of well-known devices, circuits, and methods are omitted so as not to obscure the description of the present invention with unnecessary detail. The functions of the various elements including functional blocks, including but not limited to those labeled or described as “computer”, “processor” or “controller”, may be provided through the use of hardware such as circuit hardware and/or hardware capable of executing software in the form of coded instructions stored on computer readable medium. Thus, such functions and illustrated functional blocks are to be understood as being either hardware-implemented and/or computer-implemented and are thus machine-implemented. In terms of hardware implementation, the functional blocks may include or encompass, without limitation, digital signal processor (DSP) hardware, reduced instruction set processor, hardware (e.g., digital or analog) circuitry including but not limited to application specific integrated circuit(s) (ASIC), and (where appropriate) state machines capable of performing such functions. In terms of computer implementation, a computer is generally understood to comprise one or more processors or one or more controllers, and the terms computer and processor and controller may be employed interchangeably herein. When provided by a computer or processor or controller, the functions may be provided by a single dedicated computer or processor or controller, by a single shared computer or processor or controller, or by a plurality of individual computers or processors or controllers, some of which may be shared or distributed. Moreover, use of the term “processor” or “controller” shall also be construed to refer to other hardware capable of performing such functions and/or executing software, such as the example hardware recited above.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

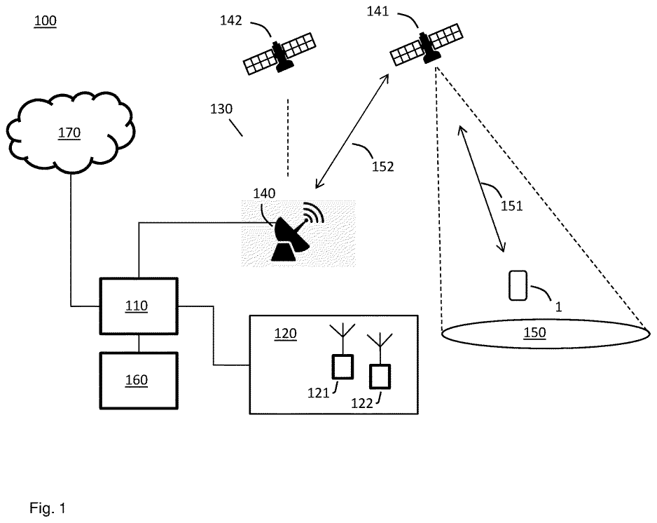

FIG. 1 schematically illustrates a wireless communication system, providing an example of a scenario in which the solutions provided herein may be incorporated. The wireless communication system includes a wireless network 100, and a UE (or wireless device) 1 configured to wirelessly communicate with the wireless network 100. The wireless network 100 comprises a core network 110, which is connected to other communication networks 170 such as the Internet. The wireless network 100 further comprises one or more access networks 120, 130, usable for communication with UEs of the system. Such access networks may comprise a terrestrial network 120 comprising a plurality of access nodes or base stations 121, 122, configured to provide a wireless interface for, inter alia, the UE 1. The base stations 121, 122 may be stationary or mobile. Each base station, such as the terrestrial base station 121, 122, comprises a point of transmission and reception, referred to as a Transmission and Reception Point (TRP), which coincides with an antenna of the respective base station. Logic for operating the base station may be configured at the TRP or at another physical location.

The access network may further comprise a non-terrestrial network (NTN) 130. The NTN 130 may comprise one or more satellites 141, 142, configured to transmit and to receive signals 151 associated with a cell of the wireless network 100 within a coverage area 150. A ground station 140 (or gateway) of the NTN 130 may be connected to the core network 110, and wirelessly connected to one or more of the satellites 141, 142. Each satellite 141, 142 may be seen as one NT node for the respective NT access node or base station, realizing one NT cell. The NT TRP communicates signals 152 with the core network 110 via the gateway 140.

In this context, the NT access node may in some examples comprise a transparent satellite 141 as an NT node. In such an example, the satellite 141 is configured as a “mirror” of a base station (e.g. gNB) part of the NT access node, which base station part is connected and may be co-located with the ground station, or gateway, 140 or in other nodes of the access network. In other examples, the NT access node may be configured with the base station part (gNB) on-board at the satellite, also referred to as a regenerative satellite.

The drawing further shows a positioning, or location, node 160 connected to or being part of the core network 110. This positioning node 160 may comprise or operate a location management function (LMF) or a location server as provided for in 3GPP specifications, and may be configured to calculate RTT and estimate a UE position based on received measurement data.

The UE 1 may be any device operable to wirelessly communicate with the network 100 through the base stations 121, 122 and/or the NTN TRPs 141, 142, such as a mobile telephone, computer, tablet, a M2M device or other.

A UE may transmit information to the wireless network 100 associated with its position based on GNSS (Global navigation satellite system) measurements. However, relying on such reported GNSS measurements may have at least the following drawbacks:
In principle, just as a malicious UE could fake its selected PLMN (Public Land Mobile Network), it could also fake its GNSS measurements;
Sending GNSS measurements over RRC (Radio Resource Control) before AS (Access Stratum) security is set up raises security and privacy issues.

Hence, the GNSS measurements (i.e., location information) provided by the UE may not be deemed to be sufficient. Another mechanism is thus needed to verify the reported GNSS measurements from the UE. For example, Radio Access Technology (RAT) dependent positioning techniques that can be deployed in NTN infrastructure can be used as a method to verify the reported GNSS measurements from the UE.

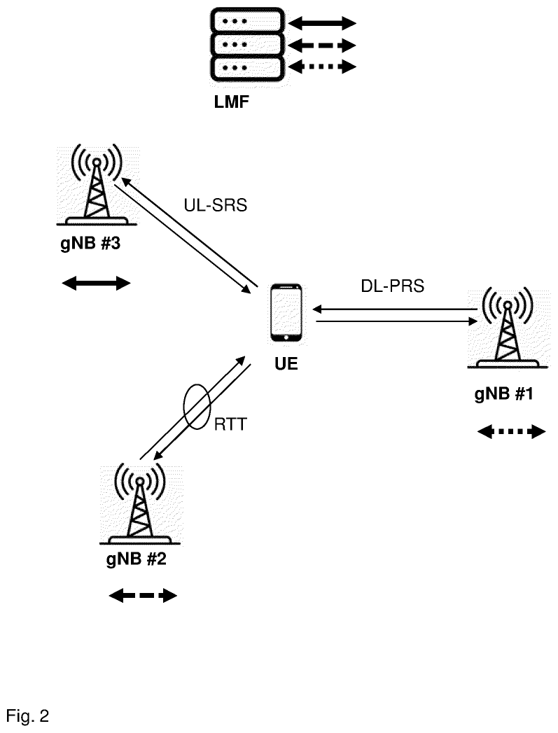

FIG. 2. schematically illustrates a RAT-dependent positioning method known as multi round-trip time (RTT) determination. This technique may be, inter alia, employed for obtaining a position, or for verifying a reported GNSS position. In a legacy terrestrial network, multi RTT positioning has been widely used. It utilizes downlink positioning reference signal (DL-PRS) and uplink sounding reference signal for positioning (UL-SRS). Each base station (gNB) used in the positioning provides DL-PRS configuration to the location server/location management function (LMF) and then the LMF provides the configuration to the UE. Furthermore, one of the base-stations (gNB) (e.g., the serving gNB) provides an UL-SRS configuration directly to the UE. Such configuration may comprise resource information, including time, periodicity, frequency, structure, etc.

The LMF will later decide/trigger which configuration is to be used for UE positioning estimation. In the case that the network (LMF) initiates the UE location information, the LMF triggers the base station to initiate the uplink SRS resource allocation and LMF also triggers the UE to perform DL-PRS measurement. Each pair of UE and gNB performs timing measurements. The UE and gNBs report the associated information to the LMF, and the LMF calculates the RTT measurement. Furthermore, the LMF performs positioning estimation using multi-lateration based on the multiple RTT results from the gNBs and UE and the true geographical position of the gNBs (e.g., the geographic coordinates).

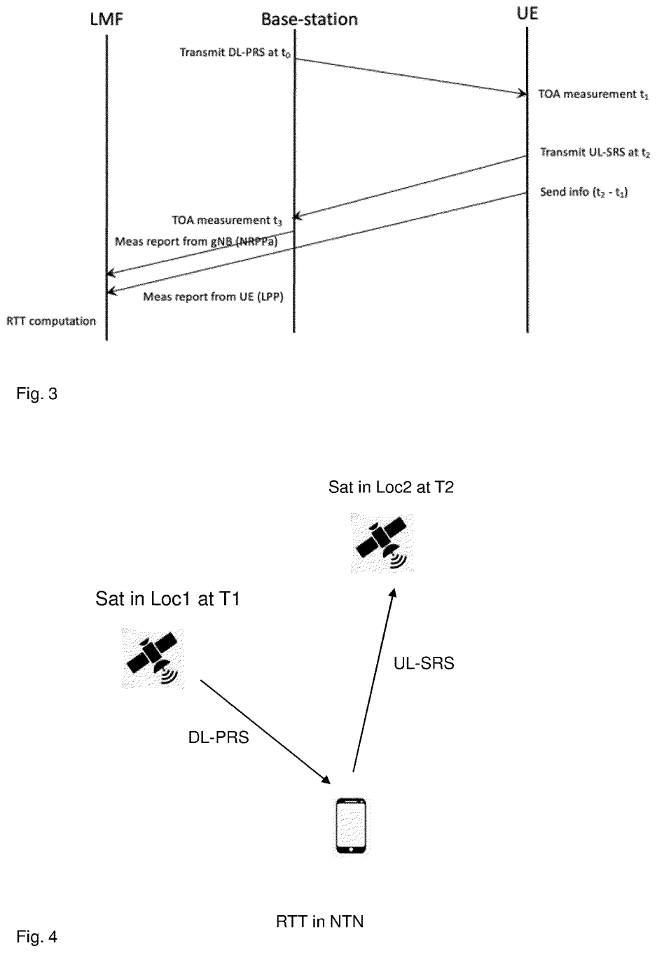

FIG. 3 illustrates one procedure for RTT measurement. RTT positioning is as such a known method to localize (position) a device by utilizing the RTT of reference signal transmissions. To carry out RTT measurements, the base station (gNB) needs to schedule bi-directional transmissions, including reference signal transmission from gNBs to a UE (using DL-PRS) and from the UE to the gNBs (using UL-SRS). As shown in the signaling diagram of FIG. 3, in a first transmission, one or more gNBs are configured to transmit a DL-PRS signal as the reference signal to the UE at time t₀. The UE measures the received PRS signal and records the reception time TOA (time of arrival) of the PRS as t₁. After that, the UE transmits a UL-SRS to the gNB. The time t₂ when the UE starts sending the UL-SRS is also recorded. The time difference between t₁ and t₂, i.e., t₂−t₁, called the UE Rx-Tx time difference, will be reported to the LMF via LPP (LTE Positioning Protocol). Likewise, the gNB Tx-Rx time difference is determined, which is the time difference between UL-SRS reception and DL-PRS transmission from the gNB side, i.e., t₃−t₀. This time difference is reported to the LMF via NRPPa (NR positioning protocol A). Having UE Rx-Tx time difference and gNB Tx-Rx time difference, the LMF can calculate the RTT as

t_RTT=(t₃−t₀)−(t₂−t₁).

Hence, the range in time between the two network nodes (e.g., BS and UE) is

t_range=t_RTT/2.

In principle, the UE needs to perform the following actions:
Measure the time-of-arrival (TOA) of the received DL-PRS signal.
Transmit a UL-SRS.
Transmit t₂−t₁, i.e., the transmission time of UL-SRS relative to the DL-PRS reception time.

Referring back to FIG. 1, some scenarios of non-terrestrial networks may be based on the use of a transparent satellite 141. The gNB is co-located with the gateway 140 or otherwise linked to the earthbound end of a feeder link 152 for the transparent scenario, whereas the NT TRP 141, also referred to as an unmanned aerial system (UAS) platform, communicates with UEs over a service link 151.

An NTN typically features the following elements:
One or several sat-gateways 140 that connect the NTN to a public data network. A geostationary earth orbit (GEO) satellite is typically fed by one or several sat-gateways 140 which are deployed across the satellite targeted coverage (e.g. regional or even continental coverage). It is assumed that UEs in a cell (150) are served by only one sat-gateway 140. A Non-GEO satellite is typically served successively by one or several sat-gateways 140 at a time. The system ensures service 151 and feeder 152 link continuity between the successive serving sat-gateways 140 with sufficient time duration to proceed with mobility anchoring and hand-over.
A feeder link or radio link 152 between a sat-gateway 140 and the satellite (or UAS platform) 141.
A service link or radio link 151 between the UE and the satellite (or UAS platform) 141.
A satellite (or UAS platform or NT TRP) which may implement either a transparent or a regenerative (with onboard processing) payload. The satellite generates beams, typically generating several beams over a given service area 150 bounded by its field of view. The footprints of the beams are typically of elliptic shape. The field of view of a satellite (or UAS platforms) depends on the onboard antenna configuration and minimum elevation angle.
Inter-satellite links (ISL), optionally in case of a constellation of satellites. This will require regenerative payloads onboard the satellites. ISL may operate in RF frequency or optical bands.
UE 1 served by the satellite (or UAS platform) within the targeted service area 150.

There may be different types of satellites (or UAS platforms or NT TRPs) as listed in the table below:

TABLE 1
Types of NTN platforms

| | | | Typical |
|---|---|---|---|
| | | | beam |
| | Altitude | | footprint |
| Platforms | range | Orbit | size |
| Low-Earth Orbit | 300-1500 | Circular around the earth | 100-1000 |
| (LEO) satellite | km | | km |
| Medium-Earth | 7000-25000 | | 100-1000 |
| Orbit (MEO) | km | | km |
| satellite | | | |
| Geostationary | 35 786 | notional station keeping | 200-3500 |
| Earth Orbit | km | position fixed in terms of | km |
| (GEO) satellite | | elevation/azimuth with | |
| UAS platform | 8-50 km | respect to a given | 5-200 |
| (including | (20 km for | earth point | km |
| HAPS) | HAPS) | | |
| High Elliptical | 400-50000 | Elliptical around the earth | 200-3500 |
| Orbit (HEO) | km | | km |
| satellite | | | |

In principle, the TN and NTN have different characteristics. One example is the cell coverage (e.g., the maximum distance between a serving gNB and its served UE) which is in the order of several kilometres (km) for TN. In NTN, the distance between a UE and the serving satellite varies a lot, as shown in the table (see the altitude range: the actual distance between the UE and satellite may be larger since the satellite is often not directly overhead and may serve the UE with an elevation angle of as little as 10 degrees). A long distance between the UE and the gNB introduces a large round-trip time (RTT) delay/propagation delay. For example, in the LEO scenario with an altitude of 600 km, the maximum RTT is around 25 ms. The 25 ms RTT is based on the propagation delays on both the feeder link 152 and the service link 151 at an elevation angle of 10 degrees, where the distance between the satellite and the UE is 1932 km (see table 4.2-2 of 3GPP TR38.821 v.16.0.0).

In TN, RTT positioning between UE and gNB assumes that the gNB is in a static position, i.e. when the gNB performs DL-PRS transmission and UL-SRS reception, the gNB is in the same position. Hence, the gNB reference point is in a single position. However, this may not be the case for RTT positioning in NTN. FIG. 4 schematically illustrates DL-PRS and UL-SRS transmission between a UE and an NT TRP (Satellite) separated in two time instances or occasions. Since the NT TRP moves between those occasions T1 and T2, which are far apart, the actual satellite position will also be quite different. Hence, in principle, there are two reference gNB positions that could be used for determining the UE position. This may affect the positioning accuracy. The existence of two reference gNB positions introduces an error in the actual gNB position for RTT position measurement (i.e., gNB reference position error). The larger the difference between the time instances T1 and T2 between DL-PRS transmission and UL-SRS transmission increases, the larger the gNB reference position error. In the multi-lateration calculation at the LMF for the UE positioning estimation, the LMF requires the multi RTT measurement results and the gNBs position. The gNB position error increases the inaccuracy of UE positioning estimation.

According to one aspect, the proposed solution involves a method carried out in a wireless network for facilitating UE positioning based on bi-directional measurement of positioning signals, said method comprising:
configuring first and second resources with mutual configuration association, wherein:
a first configuration is indicative of the first resources for transmission of downlink, DL, positioning signals by at least one access node of the wireless network,
a second configuration is indicative of the second resources for transmission of uplink, UL, positioning signals by the UE;
transmitting, to the UE, positioning configuration information identifying the configuration association.

The proposed solution thus provides a mechanism for minimizing the time gap between a first positioning signal and a second positioning signal, by jointly configuring bi-directional DL and UL positioning signals, which is particularly beneficial in NTN. In this context, the bi-directional positioning signals are associated. In TN, the UL and DL positioning signals are operated independently. Hence, the time gap between DL-PRS and UL-SRS is uncontrolled, which is acceptable in TN since the gNB does not move, but undesirable for NTN-based positioning.

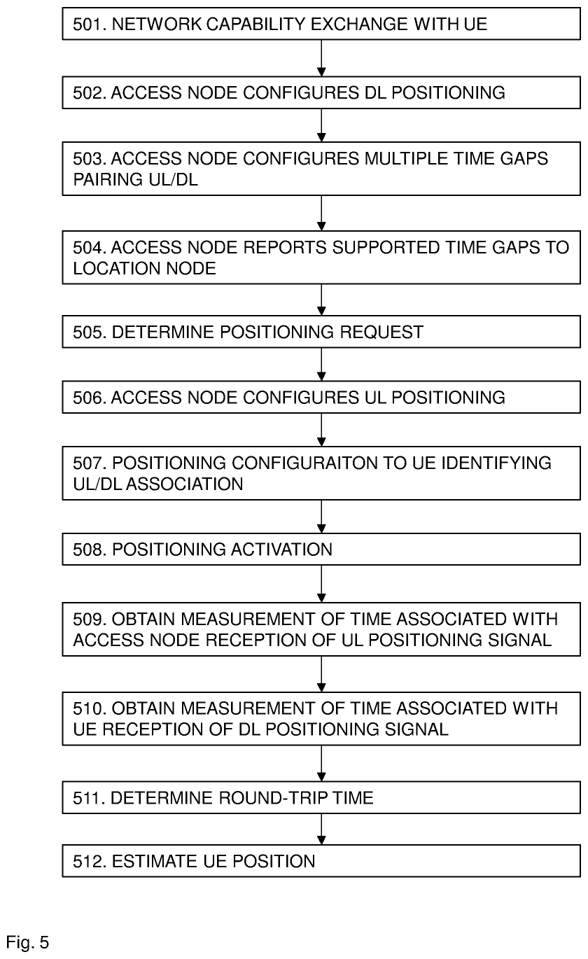

FIG. 5 shows a flowchart, including various steps that may be included in different examples of the proposed solution. These steps will first be briefly referred to, whereas various more detailed examples provided further below will be used to refer back to the general steps of FIG. 5.

In step 501, capability exchange may be carried out. This may include obtaining information in a positioning node, such as the LMF, of access node (TRP) information required for Multi-RTT positioning. This step may further involve obtainment, in the wireless network 100, of UE radio capabilities and associated information, which as such is legacy procedure. The LMF may in this context request the positioning capabilities of the UE 1 using LPP Capability Transfer procedure. According to the proposed solution, UE radio capabilities may additionally be configured to reflect capability of the UE 1 to transmit an UL positioning signal based on received configuration association with a DL positioning signal, such as whether the UE 1 has this capability, and optionally requirements or limitations on time gaps with which the UE 1 can be configured with such configuration association.

In step 502, an access node configures DL positioning. This may as such be arranged according to legacy procedures. This may be related to PRS configuration, and may include PRS resources information, including time, periodicity, frequency, PRS structure, etc. Such PRS configuration may provide static or periodic configuration of resources. This step may further comprise exchange of the DL positioning (e.g. PRS) configuration with a location node, or positioning node, 160, such as an LMF of the wireless network 100, which may be executed over NRPPa. In some examples, the positioning node may further provide the UE 1 with the determined PRS configuration, e.g. by so-called assistance data. It shall be noted that determining the DL positioning configuration by the access node and exchange with the positioning node may be independent of configuring the UE 1 and may thus take place prior to step 501. In an alternative example, the UE 1 may be configured with the DL positioning (e.g. PRS) configuration by the access node.

Step 503 shows an optional step of the access node determining multiple supported time gaps for use as configuration association, where each time gap reflects timing of UL positioning signal transmission in relation to timing of associated, or paired, DL positioning signal transmission. These time gaps may in some examples be configured by the access node, or in examples be a selection of supported time gaps forming a subset of a set of predetermined, or specified, time gaps.

In step 504, which may be included where step 503 is included, the access node may inform the positioning node of the supported time gaps.

In step 505, a positioning information request may be determined, which is associated with a positioning measurement of the UE 1. This may, according to legacy procedures, originate from the positioning node, received in the access node over NRPPa as positioning information request. The positioning information request may further indicate one or more occasions of DL positioning signal transmission, in accordance with the configuration established in step 502. According to the proposed solution, the positioning request may be indicative of positioning information based on the RTT of paired bi-directional positioning signals, i.e. with configuration association between DL and UL. In some examples, the positioning information request may further indicate a time gap for the configuration association, which may be based on information received in the positioning node in step 504. Such indication of a time gap may in some examples reflect a preferred time gap, and in other examples a mandatory configured time gap. Where steps 503 and 504 are included, the indication of a time gap may be indicative of a supported time gap reported in step 504.

In step 506, the access node serving the UE 1 determines resources available for UL positioning, e.g. UL-SRS. These resources for UL positioning signal transmission are configured based on the configuration association, with respect to the resources for DL positioning signal transmission. In some examples, this involves configuring UL (e.g. SRS) transmission resources with a time gap with respect to the determined DL (e.g. PRS) configuration. The serving access node may provide the UL positioning signal configuration information to the positioning node, e.g. in a NRPPa positioning information response message. Alternatively, the serving access node may provide a part of the entire positioning signal configuration information directly to UE 1.

It shall also be noted that UL positioning signal configuration may be determined prior to DL positioning signal configuration (step 502), wherein the (first) resources for DL positioning signal transmission are configured based on the configuration association, with respect to the second resources for UL positioning signal transmission.

In step 507, the access node transmits positioning configuration information, identifying the configuration association, to the UE 1. In one example, this provides the UE 1 with pairing information for associated UL and DL positioning signals and may be indicative of a time gap. The positioning configuration information may further configure the UE 1 with the second resources available for UL transmission of positioning signals, in accordance with the configuration association, and may comprise further information on the structure of the UL positioning signal. The positioning configuration information is, in some examples, indicative of a timing relation between the first resources, for DL positioning signal transmission, and the second resources, for UL positioning signal transmission. The positioning configuration information may be indicative of a time gap or time offset between the first resources and the second resources. In this context, the positioning configuration information identifies, based on the obtained timing of the first or the second resources, the timing to a paired resource of the other of the first and the second resources.

In some examples, positioning configuration information is indicative of a timing of at least one of said first and second resources, such as either the first resources or the second resources, or both. It shall be noted that information of timing of the resources may be transmitted in different messages and layers, than information of the configuration association.

By way of example, the configuration information may provide the first resources and a certain first periodicity or semi-persistent scheduling for DL positioning signals, and/or the second resources and a certain second periodicity or semi-persistent scheduling for UL positioning signals. The configuration association may provide pairing between occasions of DL positioning signal transmission and UL positioning signal transmission, to be applied for time measurement associated with multi RTT.

In step 508, a positioning request may be established. This may involve activating DL transmission from the access node, and if possible, from a plurality of access nodes, for UE reception, in accordance with the DL positioning signal configuration. This may further comprise activating the UE 1 to transmit UL positioning signals in accordance with the UL positioning signal configuration. The positioning request may thus serve as a trigger which is separate from the steps of providing the usable configuration to the UE and the access nodes. The positioning request may involve trigger messages from the positioning node to the UE 1 and to one or more access nodes.

In step 509, the positioning node obtains measurement of time associated with access node reception of the UL positioning signal, typically from each activated access node. This may involve transmitting, from the respective access node, the detected time difference between a time of reception of the UL positioning signal and the time of transmission of the paired DL positioning signal, in accordance with the configuration association. Alternatively, the access node only transmits the time of reception of the UL positioning signal, wherein the difference measurement is carried out in the positioning node, based on the already determined DL positioning signal configuration.

In step 510, the positioning node obtains measurement of time associated with UE 1 reception of DL positioning signals from one or more access nodes. This may involve transmitting, from the UE 1, the detected time difference between a time of reception of the DL positioning signal and the time of transmission of the paired UL positioning signal, in accordance with the configuration association. Alternatively, the UE 1 node only transmits the time of reception of the DL positioning signal, wherein the difference measurement is carried out in the positioning node, based on the already determined UL positioning signal configuration.

In step 511, the RTT determination is carried out in the positioning node, which may be carried out in accordance with legacy behavior.

In step 512, an estimate of the UE 1 position may be determined, based on the RTT determination. This may for instance involve tri-lateration based on additional determined RTT between the UE and further access nodes, according to the established art.

Before discussing further details and aspects of the proposed solution, functional elements of various devices configured to implement the proposed solution will be briefly described.

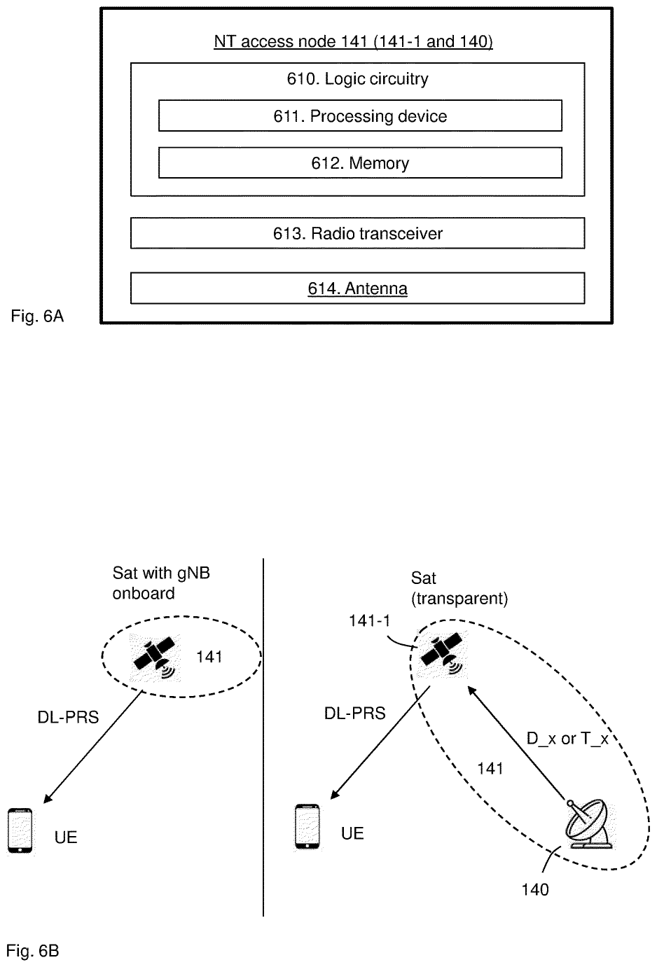

FIGS. 6A and 6B schematically illustrate an example of an access node for use in a wireless network 100 as presented herein, and for carrying out various method steps as outlined. As noted, the access node may be an NT access node 141. In this context, the access node may comprise radio base station functionality, e.g., gNB functionality, wherein the access node is configured to communicate with UEs from or via an NT node of the access node. The NT node may be a satellite.

In some examples, the access node 141 comprises circuitry configured to provide base station functionality onboard the satellite, which forms an NT node 141. This is schematically illustrated in the left part of FIG. 6B This may be referred to as regenerative payload.

In other examples, the access node 141 may be configured with at least an NT node 141-1 configured on a satellite or UAS platform, whereas radio base station functionality is partly or completely comprised in a gateway 140 or attached to the gateway, for example via a fixed wire connection. This may be referred to as transparent payload. The access node 141 may in this example comprise the gateway 140 and the NT node 141-1.

These concepts are as such known and will not be described in further detail. Reference will thus be made to FIG. 6A as the access node 141 which is configured to comprise radio base station functionality, for instance, of a gNB, and which comprises an NT node. The radio base station functionality of the access node may optionally be configured in the gateway 140 or in other terrestrial parts of the network 100.

The access node comprises logic circuitry 610 configured to control communication on a radio link, including a service link 151 for communication with UEs, and a feeder link 152 for communication with a terrestrial part of the wireless network 100, such as the gateway 140.

The logic circuitry 610 may include a processing device 611, including one or multiple processors, microprocessors, data processors, co-processors, and/or some other type of component that interprets and/or executes instructions and/or data. The processing device 611 may be implemented as hardware (e.g., a microprocessor, etc.) or a combination of hardware and software (e.g., a system-on-chip (SoC), an application-specific integrated circuit (ASIC), etc.). The processing device 611 may be configured to perform one or multiple operations based on an operating system and/or various applications or programs.

The logic circuitry 610 may further include memory storage 612, which may include one or multiple memories and/or one or multiple other types of storage mediums. For example, the memory storage 612 may include a random access memory (RAM), a dynamic random access memory (DRAM), a cache, a read only memory (ROM), a programmable read only memory (PROM), flash memory, and/or some other type of memory. The memory storage 612 may include a hard disk (e.g., a magnetic disk, an optical disk, a magneto-optic disk, a solid state disk, etc.). The memory storage 612 is configured for holding computer program code, which may be executed by the processing device 611, wherein the logic circuitry 610 is configured to control the access node to carry out any of the method steps as provided herein. Software defined by said computer program code may include an application or a program that provides a function and/or a process. The software may include device firmware, an operating system (OS), or a variety of applications that may execute in the logic circuitry 610.

The access node further comprises a radio transceiver 613 for communicating with other entities of the radio communication network 100, over, inter alia, the service link 151 and the feeder link 152. The transceiver 613 may thus include a radio receiver and transmitter for communicating through at least an air interface.

Where the access node is configured for regenerative payload, the radio transceiver 613 is configured to provide radio frequency filtering, frequency conversion and amplification as well as demodulation/decoding, switch and/or routing, coding/modulation. This is effectively equivalent to having all or part of the base station functions (e.g. gNB) onboard the satellite.

Where the access node is configured for transparent payload, the radio transceiver 613 is configured to provide radio frequency filtering, frequency conversion and amplification. Hence, the waveform signal repeated by the payload, between feeder link and service link, is unchanged.

The access node may further comprise an antenna system 614, which may include one or more antenna arrays. In various examples the access node is configured to operate with a single beam, wherein the antenna system 614 is configured to provide an isotropic sensitivity to transmit radio signals. In other examples, the antenna system 614 may comprise a plurality of antennas for operation of different beams in transmission and/or reception.

Obviously, the access node may include other features and elements than those shown in the drawing or described herein, such as a power supply, a casing, sensors, etc., but are left out for the sake of simplicity.

In one aspect of the proposed solution, the access node is configured to be usable for UE positioning based on bi-directional measurement of positioning signals. The access node being configured to:

transmit, to the UE, a first configuration indicative of resources for an UL positioning signal for transmission from the UE;
transmit, to the UE, positioning configuration information to the UE,
wherein the positioning configuration information is indicative of configuration association between the resources for the UL positioning signal and further resources of a further configuration for a DL positioning signal for reception in the UE from the access node.

In this context, the positioning configuration information may identify timing between paired configured resources for UL and DL signaling for use in RTT determination. The first resources may be configured for UL transmission, e.g. SRS, and the configuration association configures the UE to determine an occasion of a received DL positioning signal, e.g. PRS, which is to be associated (paired) with the UL signal, for determining the associated time difference between DL reception and UL transmission in the UE. This is particularly useful in the context of an NT access node, as it provides for configuration which minimizes negative effects caused by satellite to UE distance and satellite movement during the RTT measurement process.

In some examples, the logic circuitry 610 may be configured to determine positioning signal configuration. This may include a first configuration identifying first resources for transmission of downlink, DL, positioning signals by the access node, and a second configuration identifying second resources for transmission of uplink, UL, positioning signals by the UE 1. In this context, determining may comprise configuring resources and/or determining the configuration based on an indication received from e.g. the positioning node 160, and/or determining, based on time configuration of one of the first and second resources and on the configuration information, the time configuration of the other of the first and second resources. The logic circuitry may further be configured to transmit, to the UE 1 using the radio transceiver, the positioning configuration information identifying configuration association between the first resources and the second resources.

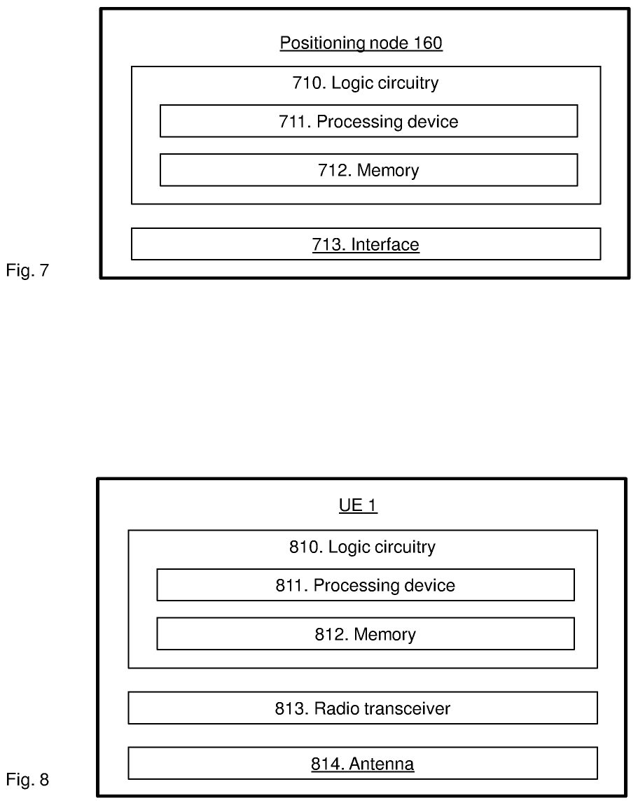

FIG. 7 schematically illustrates an example of a positioning node 160 for use in a wireless network 100 as presented herein, and for carrying out various method steps as outlined. The positioning node may provide functionality of an LMF.

The positioning node 160 comprises logic circuitry 710 configured to provide configuration information with other entities of the wireless network 100, including various access nodes of a RAN 120, 130 and with UEs via the RAN. The positioning node further comprises circuitry and program code for making calculations and position estimations of UEs.

The logic circuitry 710 may include a processing device 711, including one or multiple processors, microprocessors, data processors, co-processors, and/or some other type of component that interprets and/or executes instructions and/or data. The processing device 711 may be implemented as hardware (e.g., a microprocessor, etc.) or a combination of hardware and software (e.g., a system-on-chip (SoC), an application-specific integrated circuit (ASIC), etc.). The processing device 711 may be configured to perform one or multiple operations based on an operating system and/or various applications or programs.

The logic circuitry 710 may further include memory storage 712, which may include one or multiple memories and/or one or multiple other types of storage mediums. For example, the memory storage 712 may include a random access memory (RAM), a dynamic random access memory (DRAM), a cache, a read only memory (ROM), a programmable read only memory (PROM), flash memory, and/or some other type of memory. The memory storage 712 may include a hard disk (e.g., a magnetic disk, an optical disk, a magneto-optic disk, a solid state disk, etc.). The memory storage 712 is configured for holding computer program code, which may be executed by the processing device 711, wherein the logic circuitry 710 is configured to control the positioning node 160 to carry out any of the method steps as provided herein. Software defined by said computer program code may include an application or a program that provides a function and/or a process. The software may include device firmware, an operating system (OS), or a variety of applications that may execute in the logic circuitry 710.

The positioning node 160 may be realized in the cloud, or in one or more partitions of the core network 110, and may share parts of the logic circuitry with other entities of the wireless network 100.

The positioning node comprises one or more interfaces 713 for communicating with the RAN and with UEs, and with other entities of the wireless network 100.

In one aspect, the location node 160 may be configured for facilitating UE positioning based on bi-directional measurement of positioning signals, wherein the logic circuitry 710 is configured to:
obtain a first configuration indicative of first resources for transmission of downlink, DL, positioning signals by at least one access node of the wireless network;
transmit, to said at least one access node, a positioning request associated with the UE, indicative of positioning with pairing between uplink, UL, and the DL positioning signals,
wherein said positioning request with pairing configures the at least one access node to transmit, to the UE, configuration information indicative of configuration association between the first resources and second resources for UE transmission of the UL positioning signal.

In some examples, the positioning node is further configured to determine round-trip time between the UE and one or more of the at least one access node using measurement data obtained based on at least one DL positioning signal and at least one UL positioning signal which are transmitted according to said configuration association.

In this context, the positioning configuration information may identify timing between paired configured resources for UL and DL signaling for use in RTT determination. This is particularly useful in the context of an NT access node, as it provides for configuration which minimizes negative effects caused by satellite to UE distance and satellite movement during the RTT measurement process.

FIG. 8 schematically illustrates an example of a UE 1 for use in a wireless network 100 as presented herein, and for carrying out various method steps as outlined.

The UE 1 comprises logic circuitry 810 configured to control operation of the UE 1, including to control radio communication.

The logic circuitry 810 may include a processing device 811, including one or multiple processors, microprocessors, data processors, co-processors, and/or some other type of component that interprets and/or executes instructions and/or data. The processing device 811 may be implemented as hardware (e.g., a microprocessor, etc.) or a combination of hardware and software (e.g., a system-on-chip (SoC), an application-specific integrated circuit (ASIC), etc.). The processing device 811 may be configured to perform one or multiple operations based on an operating system and/or various applications or programs.

The logic circuitry 810 may further include memory storage 812, which may include one or multiple memories and/or one or multiple other types of storage mediums. For example, the memory storage 812 may include a random access memory (RAM), a dynamic random access memory (DRAM), a cache, a read only memory (ROM), a programmable read only memory (PROM), flash memory, and/or some other type of memory. The memory storage 812 may include a hard disk (e.g., a magnetic disk, an optical disk, a magneto-optic disk, a solid state disk, etc.). The memory storage 812 is configured for holding computer program code, which may be executed by the processing device 811, wherein the logic circuitry 810 is configured to control the UE 1 to carry out any of the method steps as provided herein. Software defined by said computer program code may include an application or a program that provides a function and/or a process. The software may include device firmware, an operating system (OS), or a variety of applications that may execute in the logic circuitry 810.

The UE 1 further comprises a radio transceiver 813 for communicating with other entities of the radio communication network 100, such as the access node 141 in different frequency bands. The transceiver 813 may thus include a radio receiver and transmitter for communicating through at least an air interface.

The UE 1 may further comprise an antenna system 814, which may include one or more antenna arrays. In various examples the UE 1 is configured to operate with a single beam, wherein the antenna system 814 is configured to provide an isotropic sensitivity to transmit radio signals. In other examples, the antenna system 814 may comprise a plurality of antennas for operation of different beams in transmission and/or reception.

Obviously, the UE 1 may include other features and elements than those shown in the drawing or described herein, such as a power supply, a casing, a user interface, sensors, etc., but are left out for the sake of simplicity.

In one aspect, the UE is operable in a wireless network configured for UE positioning based on bi-directional measurement of positioning signals. The UE 1 may comprise the logic circuitry 811 and the radio transceiver 813.

The UE may be configured to obtain configuration information indicative of:
a first configuration of first resources for transmission of downlink, DL, positioning signals by at least one access node of the wireless network,
a second configuration of second resources for transmission of uplink, UL, positioning signals by the UE, and
configuration association between the first resources and the second resources.

A method of operating the UE 1 for facilitating UE positioning in a wireless network based on bi-directional measurement of positioning signals is further provided. The method comprises:
receiving configuration information indicative of:
a first configuration of first resources for a downlink, DL, positioning signal for transmission by at least one access node of the wireless network,
a second configuration of second resources for an uplink, UL, positioning signal for transmission by the UE, and
configuration association between the first resources and the second resources.

In some examples, the method further comprises:
receiving an activation signal to trigger a positioning procedure with pairing between UL and DL positioning signals.

In some examples, the method further comprises:
transmitting an UL positioning signal according to the second configuration;
monitoring reception of a DL positioning signal according to the first configuration;
measuring time between UL positioning signal transmission and an occasion of DL positioning signal reception, based on the configuration association.

In some examples, the method further comprises:
transmitting, to the wireless network, a measurement report identifying time of reception in the UE of at least one of the DL positioning signals in relation to the transmission of the UL positioning signal.

In this context, the positioning configuration information may identify timing between paired configured resources for UL and DL signaling for use in RTT determination. This is particularly useful in the context of an NT access node, as it provides for configuration which minimizes negative effects caused by satellite to UE distance and satellite movement during the RTT measurement process. The configuration information may be indicative of a timing relation between the first resources and the second resources.

Further aspects and examples of the proposed solution will now be described, which may be carried out using the functional methods and devices described above. In these examples, DL-PRS will be used to identify a DL positioning signal, and UL-SRS will be used to identify an UL positioning signal, which are known legacy terms. It should be noted, though, that these specific signals may be replaced with other reference signals which provide the purpose of use as positioning signals. Moreover, the positioning node is referred to as an LMF, by way of example.

The proposed solution involves the notion of applying a configuration association between positioning signals in the UL and the DL for RTT measurement purposes. This may be used to minimize the time gap between a first positioning signal and a second positioning signal by jointly configuring both DL and UL positioning signals. This may be particularly beneficial in an NTN 130, i.e., where at least one access node 141 comprises an NT node 141-1. In TN, the UL and DL positioning signals are operated independently. Hence, the time gap between DL-PRS and UL-SRS is uncontrolled, which is acceptable in TN since the gNB does not move, but it is undesirable for NTN-based positioning.

According to the proposed solution, the UE 1 to be positioned is configured with positioning configuration information identifying the configuration association for bi-directional positioning signals in DL and UL. The positioning configuration information may be indicative of a timing relation between first resources for transmission of a positioning signal in a first direction of DL or UL, and second resources for transmission in the other, complementary direction.

In some examples, the positioning configuration information is indicative of a time gap or time offset between the first resources and the second resources. The UE 1 may also be configured with positioning configuration information indicative of a timing of at least one of said first and second resources, as described with reference to step 502 and or step 506.

In one example, the time gap between DL-PRS transmission and UL-SRS transmission is configured by the network (e.g., the access node 141), and is signaled to the UE 1 as described with reference to step 507. The time gap information can be provided in an RRC message. As described with reference to step 503, multiple possible time gaps may be pre-configured to be available/selectable, of which one may be selected, either based on an indication by the positioning node 160 or by the access node 141, as described with reference to step 505. The time gap may be informed, to the UE 1, by a lower layer message (e.g., DL MAC CE or Downlink Control Information (DCI)).

In various examples of the proposed solution, the time gap refers to slots in which a DL-PRS and an UL-SRS are transmitted before timing advance is applied. The actual time, determined in the UE 1, between DL-PRS reception and UL-SRS transmission is one of the things that is signaled between the UE 1 and the network.

In some examples, the time gap of DL-PRS transmission and UL-SRS transmission is indicated by the LMF 160 to the serving access node 141. For example, this indication is in a form of assistance information. Based on resource allocation by the access node 141, the access node 141 can follow the indication/request from LMF or provide another possible configuration. The access node 141 then provides/informs the selected configuration association, (i.e., the time gap) information, back to the LMF 160.

In some examples, the timing of one positioning signal (UL or DL) can be the reference for the other positioning signal, of associated bi-directional positioning signals. For example, the DL-PRS transmission time is the reference for the UL-SRS transmission time, or vice versa. That is, the joint configuration of DL-PRS and UL-SRS is performed such that each DL-PRS occasion is paired with an UL-SRS occasion. The said time gap is therefore the time between a paired UL-SRS and DL-PRS.

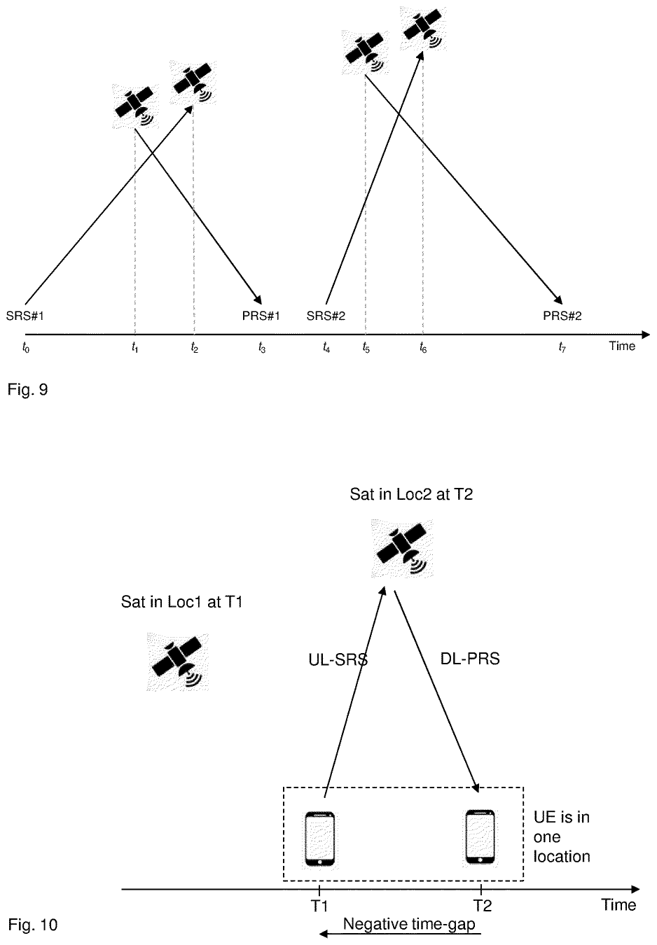

FIG. 9 illustrates an example implementation of the proposed solution, where a pair of periodic UL-SRS and DL-PRS is configured. Here the UE 1 transmits an UL-SRS, i.e. SRS #1 at time t₀, and receives a DL-PRS, i.e., PRS #1 at time t₃, where PRS #1 is transmitted by the satellite at time t₁. Although the UE transmits another UL-SRS (SRS #2) at time t₄, which is closer in time to the reception of PRS #1, the pairing (configuration association) is configured such that PRS #1 is paired with SRS #1. The pairing may in this context comprise or be indicative of a time gap or offset. Where the configuration association is configured from the satellite perspective of time, the time gap will in this example be t₂−t₁. Where the configuration association is configured from the UE perspective of time, the time gap will in this example be t₃−t₀. The advantage of this pairing is that SRS #1 would arrive at time t₂, which is shortly after the satellite (i.e. the NT node 141-1 of the access node 141) had transmitted PRS #1 and by pairing SRS #1 and PRS #1 for the multi RTT calculation, the changes in satellite locations between the satellite transmitting PRS #1 and receiving SRS #1 is reduced. In contrast, operation according to legacy procedures (as in FIG. 3) would pair the DL-PRS and UL-SRS that are closest in time with respect to reception and transmission at the UE, i.e., PRS #1 would be paired with SRS #2. This would result in performing multi-RTT calculation where the satellite has changed its location by a larger amount, which would introduce error in determining the location of the UE 1, since the multi-RTT calculation assumes a stationary access node. Note that the time gap can be defined as the timing of the SRS relative to the PRS (such that a positive time gap relates to an SRS being received at the satellite at a later time than the PRS is transmitted by the satellite). Alternatively, the time gap can be defined as the timing of the PRS relative to the SRS (such that a positive time gap relates to a PRS being transmitted by the satellite at a later time than the SRS is received by the satellite). In these cases, the sign of the time gap can be used to indicate whether the SRS is received by the satellite before the PRS is transmitted or vice versa.

FIG. 10 illustrates a variant of the example of FIG. 9. Herein, the configuration association comprises a negative time gap or offset, with regard to a reference time of the DL-PRS. Referring to the previous example in FIG. 9, here, the pairing of UL-SRS is such that the scheduled UL-SRS reception at the satellite is earlier than the scheduled DL-PRS transmission. The negative time gap or offset needs to take into account the propagation time delay which depends on the distance between satellite and UE (or at least the approximate distance between the satellite and UE, where the approximate distance is known based on the known beam footprint of the satellite). In the case of a LEO satellite, the negative time gap can be on the order of 20 ms. In another example, the time gap can also be positive (in which case it may increase the access node reference point positioning error).

The proposed solution, e.g. as exemplified with reference to FIGS. 9 and 10, provides that the positioning configuration information may configure the UE 1 to transmit the UL positioning signal prior to monitoring for reception of the DL positioning signal in accordance with the identified configuration association, such as a configured time gap or offset. As a consequence, the time difference between DL-PRS transmission and UL-SRS reception can be minimized at the satellite, such that negative impact on positioning accuracy caused by movement of the satellite (NT node 141-1) of the access node is mitigated. In legacy systems (i.e. Rel-17 and earlier 3GPP specifications), the UE RX-TX time difference measurement relates to the PRS and SRS that are closest in time from a UE perspective (i.e. the closest UE DL-PRS RX and UE UL-SRS TX in time). The following text is taken from 3GPP TS38.215 V17.2.0: “TUE-TX is the UE transmit timing of uplink subframe #j that is closest in time to the subframe #i received from the positioning node”. This definition removes the ambiguity of which SRS and PRS are used in the time difference measurement. If a similar approach were taken for NTN, the PRS occasions would have to be separated by a time that is greater than the potential propagation time difference in the NTN cell in order to remove ambiguity of the UE TX-RX time difference measurement. In contrast, an advantage of the proposed solution is that the ambiguity of the UE TX-RX time difference measurement is removed by the configuration association. This moreover allows periodic PRS occasions to be more closely spaced in time without creating ambiguity.

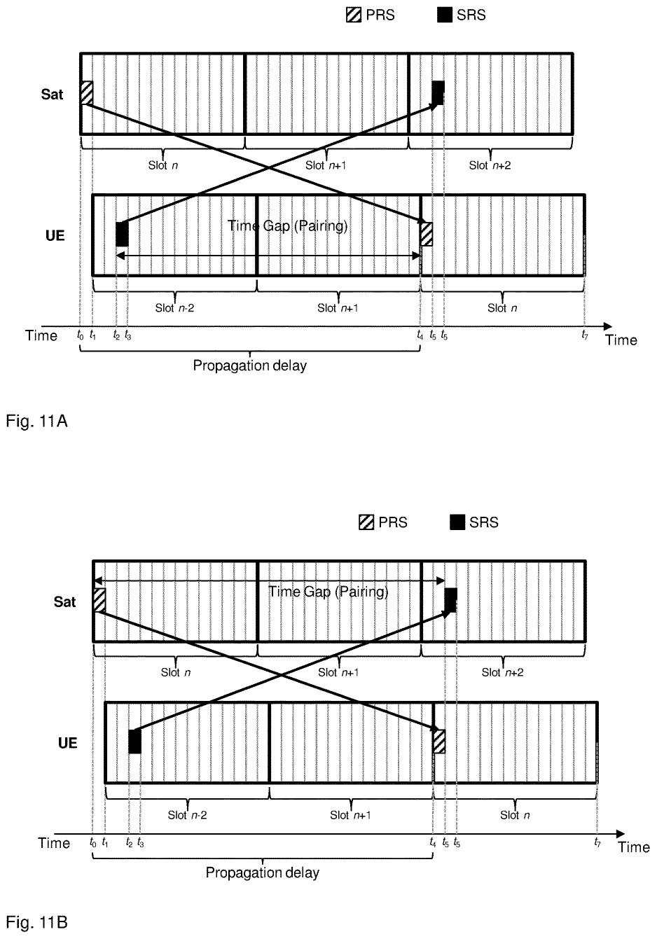

FIGS. 11A and 11B illustrate time diagrams for examples of the proposed solution. At the top of each figure, timing of positioning signals is indicated for the access node 141, comprising an NT node or satellite, and at the bottom the timing of positioning signals is indicated for the UE 1. In these examples, the access node is configured with a first configuration indicative of first resources (dashed box in upper part) for transmission of a DL-PRS. The UE 1 is configured with a second configuration indicative of second resources (black box in lower part) for transmission of an UL positioning signal. The UE 1 is configured with positioning configuration information identifying a configuration association, which provides pairing between the UL-SRS transmission and the DL-PRS reception.

FIG. 11A provides an example where the configuration association is configured from the perspective of the UE 1. In this example, the configuration association comprises a time gap or offset t₄−t₂.

FIG. 11B provides an example where the time gap of the configuration association is alternatively defined with reference to the frame structure at the access node 141 or NT node 141-1. In this example, the time gap is configured as t₅−t₀, where t₀ is the time at which the DL PRS is transmitted by the access node and t₅ is the time at which the UL SRS is to be received at the access node.

The time gap information has an important role in controlling the time separation between the DL PRS transmission time and UL SRS reception time at the NT node. The NT node positioning error can be minimized so that the DL PRS transmission time and UL SRS reception time at the NT node can be very close in time by controlling the time gap information.

The UE 1 will receive DL PRS at the configured time, and transmit UL-SRS such that it arrives at the satellite at the configured time, based on the configuration association, according to the received frame structure at the UE 1. Notably, the frame structure will be time-shifted due to propagation delay with regard to the access node 141. The UE 1 will have had to timing advance the UL transmission such that a UL-SRS transmission configured e.g. in the n^{th} OFDM symbol of slot 2 will also arrive there at the access node 141. For this reason, the UE needs to signal the RX-TX time measurement—the time difference between TX and RX at the UE depends on the timing advance applied by the UE.

It may further be noted that RX time of the DL-PRS in the UE 1 is not necessarily the same as the RX time of the DL OFDM symbol boundary. The timing of the DL OFDM symbol boundary might be defined by the peak of some correlation whereas the timing of the DL PRS is defined by the first significant peak in some correlation. Hence, the offset between DL OFDM symbol boundary and DL-PRS at the access node can be different to the offset between the DL OFDM symbol boundary and DL-PRS as measured at the UE.

In some examples, satellite position (for the NT node of the access node 141) and/or time stamp when it transmits DL-PRS and receives UL-SRS is provided by the access node 141 to the LMF 160. The satellite position and/or the time stamp information can be in a form of relative position/time stamp, in this case relative to a reference point (e.g., a first measurement). It can also be in a form of the exact time, such as exact geographical coordinate and/or exact time stamp (global time information). This information may be used for the UE positioning estimation purpose, which may be used by the LMF 160 to factor out the changes to satellite position when transmitting DL-PRS and receiving UL-PRS in multi RTT calculation, thereby reducing error caused by satellite movements. In another example, one of the satellite positions and/or time stamps of one positioning signal (e.g., DL-PRS transmission) is reported to the LMF 160. In this case, the other position is not reported as it is considered as the error (or uncertainty) of the satellite reference position.

In some examples, the satellite gateway 140 provides the LMF 160 with the satellite position information when the DL-PRS is transmitted and when the UL-SRS is received. For example, the LMF 160 can send an information request to the satellite gateway 140, asking the satellite gateway 140 for the location of the satellite at the times of DL-PRS transmission and UL-SRS reception. As noted, the satellite gateway 140 may in this context comprise the gNB part of the access node, for the transparent payload example.

The LMF 160 may also be configured to also factor out changes in satellite position by having accurate ephemeris information, where the ephemeris information describes the orbit of the satellite.

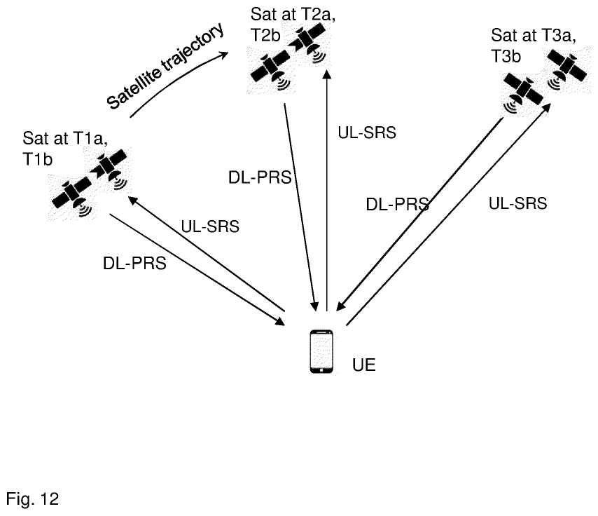

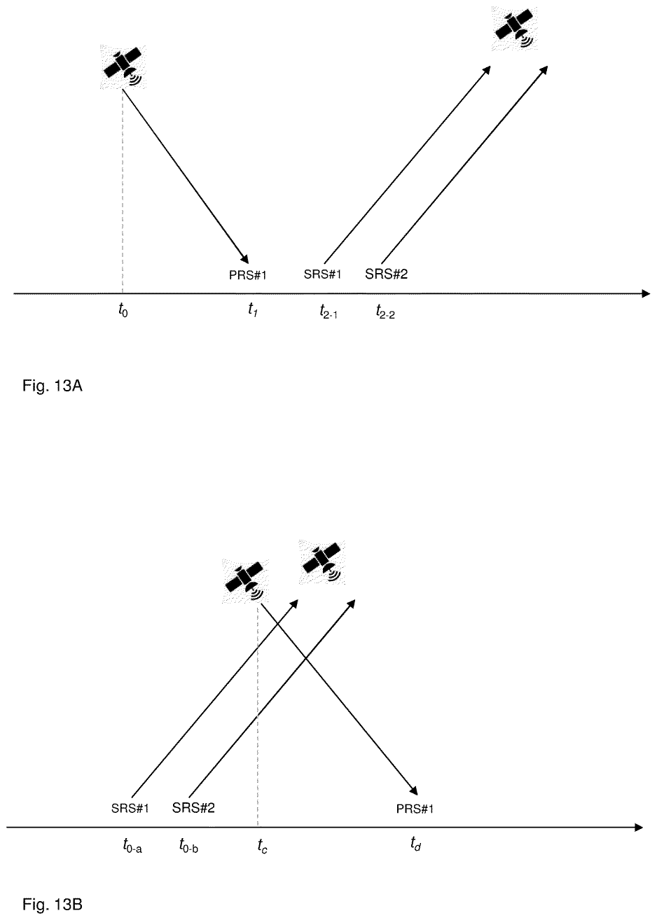

In some examples, Multi-RTT in NTN may be based on a single satellite (NT node 141-1 of the access node). In this case, RTT measurements from a single satellite are required to provide multi-RTT positioning. This is schematically illustrated in FIG. 12. Here, there are 3 RTT occasions, carried out with a single satellite at 3 different positions. The LMF may be configured to carry out multi-lateration based on at least said 3 RTT occasions. This may be, inter alia, carried out based on the solution discussed in WO2022/106139A2. In one example, a UE 1 can be configured with multiple RTT occasions. In another example, the time interval between occasions can be identical or different. For example, the time gap between T1 and T2 is the same as the time gap between T2 and T3. In another example, the reference configuration for each occasion can be identical or different. Identical configuration can simplify the configuration exchange. On the other hand, different configurations may be needed as the distance between satellite and UE can change significantly, depending on the satellite position along the trajectory. In the case of LEO satellites and where the satellite position is at the minimum elevation, the distance can be more than 3× of the minimum distance (when the LEO satellite is at the zenith). In such case, the pathloss between the UE and satellite will change significantly and the reference signals for positioning can have different numbers of repetitions.

The UL and DL link budgets are usually different, where the UL link budget is more challenging, since the transmit power of the UE 1 is limited compared to the transmit power of the satellite. Hence, UL SRS reception at the satellite (and hence at the access node) can be unreliable even though DL-PRS reception at the UE is reliable. According to one example of the proposed solution, more than one UL-SRS occasion is associated with a single DL-PRS occasion. This is schematically illustrated in FIGS. 13A and 13B. The access node 141, of which the NT node 141-1 satellite is shown in the drawings, can then combine the measurements from receptions of the multiple UL-SRS in order to determine a more accurate measurement of UL SRS reception timing. In this example, the UE may be configured with resources for a plurality of UL positioning signal transmission occasions, and with positioning configuration indicative of pairing of one DL positioning signal transmission occasion with said plurality of UL positioning signal transmission occasions.

In one variant of the example employing multiple UL-SRS transmission, the UE 1 is configured to send UE RX-TX time difference measurements for each UL-SRS. For example, as shown in FIG. 13A, when the UE 1 is configured with DL-PRS1 (transmitted by the access node at time t₀ and received by the UE 1 at time t₁) being associated with UL-SRS1 (at time t₂₋₁) and UL-SRS2 (at time t₂₋₂), the UE 1 reports (step 510) UE RX-TX time difference measurements:
t₂₋₁−t₁ relating to UL-SRS1 and DL-PRS1.
t₂₋₂−t₁ relating to UL-SRS2 and DL-PRS1

For an example as shown in FIG. 13B, when the UE 1 is configured with DL-PRS1 (transmitted by the access node at time t_{c} and received by the UE 1 at time t_{d}) being associated with UL-SRS1 (at time t₀₋ₐ) and UL-SRS2 (at time t_{0-b}), the UE 1 reports (step 510) UE RX-TX time difference measurements:
t_{d}−t₀₋ₐ relating to UL-SRS1 and DL-PRS1
t_{d}−t_{0-b} relating to UL-SRS2 and DL-PRS1

The UE 1 may be configured to report directly to the LMF 160 over LPP. Alternatively, the UE 1 is configured to report to the access node 141, which reports to the LMF 160. The access node 141 may report (step 509) either multiple UE RX-TX time difference and access node RX-TX time difference measurements to the LMF, according to the above bulleted list, or report single UE RX-TX time difference and access node RX-TX time difference measurements to the LMF, where the single measurements are formed from combining (e.g. averaging, taking into account the different nominal transmission times of UL-SRS1 and UL-SRS2) the individual UE RX-TX time difference and access node RX-TX time difference measurements.

In another variant, described with reference to FIG. 13A but applicable in the corresponding manner to FIG. 13B, the UE 1 sends a single UE RX-TX time difference measurement for the group of UL-SRS. For example, when the UE 1 is configured with DL-PRS1 (at time t₀) being associated with UL-SRS1 (at time t₂₋₁) and UL-SRS2 (at time t₂₋₂), the UE 1 reports the UE RX-TX time difference measurement:
t₂₋₁−t₁ relating to UL-SRS1 and DL-PRS1

In this case, the access node 141 (or the LMF 160) can combine the timing measurements of UL-SRS1 and UL-SRS2, accounting for the known nominal time delay between the transmission of UL-SRS1 and UL-SRS2 (e.g. if UL_SRS1 and UL_SRS2 are configured to be transmitted 10 slots apart, the nominal 10 slots of timing can be removed between the time of arrival measurements of UL-SRS1 and UL_SRS2). Assuming UL-SRS1 and UL-SRS2 are transmitted closely in time, the propagation delay between UE 1 and satellite 141 should not have changed significantly between transmissions of these UL-SRS. In case of this variant, the UE 1 shall maintain applied timing advance between transmission of UL-SRS1 and UL-SRS2.

It may be noted that the UL-SRS are timing advanced and hence should arrive in known slots (and indeed within known OFDM symbols, or with even tighter timing granularity), as indicated for a single UL-SRS in FIG. 11. There should hence be no time-based ambiguity in terms of which UL-SRS are being received.

In one example, when one of the UL-SRS positioning signals is unable to be performed/processed (i.e, due to the collision with other transmission/receptions), the other UL-SRS positioning signal(s) may be dropped. Hence, the entire RTT occasion is not performed. For example, if the UE 1 is unable to transmit the UL-SRS then the RTT occasion involving this UL-SRS will be dropped. Here the UE may skip monitoring the corresponding (paired) DL-PRS.

In some examples, in the case of the multi-RTT, both UE 1 and access node 141 collects/obtains time measurements at different occasions and reports those measurements in one, respective collected report to the LMF 160, i.e, one report contains multiple time measurements at different occasions. For example, the UE 1 may be configured to send one report containing multiple UE RX-TX time difference measurements and the access node 141 may be configured to send one report containing multiple access node TX-RX time difference measurements. These measurement report may be used in the LMF 160 for obtaining a positioning estimate.

With reference back to FIG. 6B (right), in some examples the access node 141 measures the distance information (D_x) and/or estimated timing measurement information (T_x) between satellite 141-1 and the gateway 140. This measurement information is later provided to the LMF 160. Hence, the LMF 160 is configured to be able to calculate the RTT between satellite 141-1 and the UE 1 by taking into account D_x and/or T_x parameters. This is particularly applicable for the case of a satellite with transparent payload as shown in the right part of FIG. 6B. In the satellite transparent case, the DL-PRS experiences two propagation times, gNB (located at gateway 140) to satellite 141-1 (T_x) and satellite 141-1 to UE 1. When the LMF 160 performs RTT measurement, the propagation time between gNB 140 to satellite 141-1 should be known so that it can be accounted for during RTT calculations.

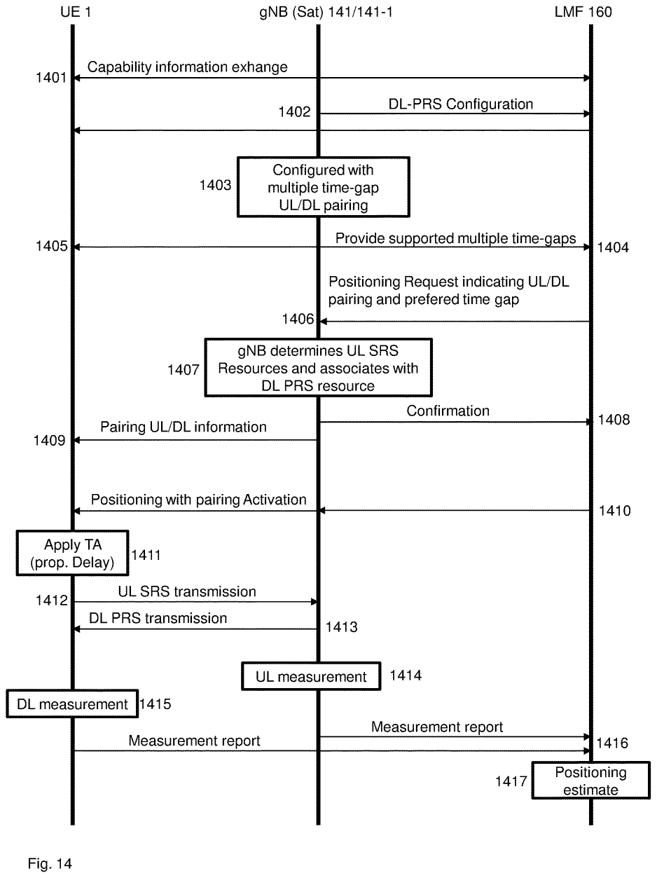

FIG. 14 shows a signaling diagram of possible implementations according to various examples of the proposed solution, including those described above. The diagram shows the UE 1 and its serving access node 141. The access node 141 may be configured as a satellite or UAS, e.g. as regenerative payload. Alternatively, the access node 141 at least comprises an NT node 141-1 configured as a satellite or UAS, and base station circuitry configured in a gateway 140 or other terrestrial node. It may be noted that further access nodes may typically be involved in the RTT process, with reference to legacy procedure, but these are left out for the sake of simplicity. A positioning node 160 is included, which may be an LMF 160. Signaling according to FIG. 14 may in various parts correspond to the method described with reference to FIG. 5, and reference to corresponding method steps is therefore made below. Various details provided with reference to FIG. 5 are left out below but may be included in examples according to FIG. 14 too.

1401 indicates capability information exchange, corresponding to step 501. This may include obtaining information in LMF 160 of access node information required for Multi-RTT positioning, and obtainment of UE radio capabilities.

1402 indicates DL-PRS configuration, wherein the access node 141 configures DL positioning. This corresponds to step 502. This may include sharing DL-PRS configuration with the LMF 160 and the UE 1. DL-PRS configuration may comprise a first configuration which is indicative of first resources for transmission of a DL positioning signals by the access node 141.

1403, corresponding to step 503, indicates an optional step of the access node 141 determining multiple supported time gaps for use as configuration association, where each time gap reflects timing of UL positioning signal transmission in relation to timing of associated, or paired, UL positioning signal transmission. These time gaps may in some examples be configured by the access node, or in examples be a selection of supported time gaps forming a subset of a set of predetermined, or specified, time gaps.

1404 indicates that, where the configuration according to 1403 is executed, the access node 141 may further inform the LMF 160 of the supported time gaps.

Further, as indicated at 1405, the access node 141, or the LMF 160, may configure the UE 1 with configuration of supported time gaps, which can be triggered in a subsequent positioning request or activation. The UE 1 may receive the configuration of supported time gaps via higher layer protocol, such as RRC if it is sent from the access node 141 or LPP if it is sent from the LMF 160.

At 1406, the LMF may send a positioning information request to the access node 141, which is associated with a positioning measurement of the UE 1. This corresponds to step 505. According to the proposed solution, the positioning request may be indicative of positioning information based RTT of paired bi-directional positioning signals, i.e. with configuration association between DL and UL. This may be implicitly indicated based on other factors or parameters, such as the access node comprising an NT node 141, 141-1, or explicitly. In some examples, the positioning information request may further indicate a time gap for the configuration association, which may be based on information received in the positioning node in step 1504. Such indication of a time gap may in some examples reflect a preferred time gap, and in on other examples a mandatory configured time gap. Where steps 1503 and 1504 are included, the indication of a time gap may be indicative of a supported time gap reported at 1404.

1407 indicates, corresponding to step 506, that the access node 141 serving the UE 1 determines resources available for UL positioning, e.g. UL-SRS. These resources for UL positioning transmission may be configured based on the configuration association, with respect to the resources for DL positioning signal transmission. In some examples, this involves configuring UL (e.g. SRS) transmission resources with a time gap with respect to the determined DL (e.g. PRS) configuration.

At 1408, the serving access node 141 may provide confirmation to indicate to the LMF 160 whether the requested configuration, such as the time gap, can be provided or not by the access node 141. Furthermore, the access node 141 can also indicate which configuration, such as the time gap, can be provided to the UE 1, e.g. in a NRPPa positioning information response message, denoted Confirmation in the drawing. At this step, the access node 141 may further report the UL positioning signal configuration to the positioning node 160.

At 1409, corresponding to step 507, the access node 141 transmits positioning configuration information, identifying the configuration association, to the UE 1. In one example, this provides the UE 1 with pairing information for associated UL and DL positioning signals and may be indicative of a time gap. This may comprise specific identification of a time gap, or identification of a selection of a time gap reported at 1405. The positioning configuration information may further configure the UE 1 with resources for UL transmission of positioning signals, in accordance with the configuration association, and may comprise further information on structure of the UL positioning signal. The positioning configuration information may be indicative of a time gap or time offset between the first resources and the second resources. In this context, the positioning configuration information identifies, based on the obtained timing of the first or the second resources, the timing to a paired resource of the other of the first and the second resources.

In some examples, positioning configuration information is indicative of a timing of at least one of said first and second resources, such as either the first resources or the second resources, or both. It shall be noted that information of timing of the resources may be transmitted in different messages and layers, than information of the configuration association.

At 1410, corresponding to step 508, a positioning request may be established, which triggers activation of DL transmission from the access node, and preferably a plurality of access nodes, for UE reception, in accordance with the DL positioning signal configuration. It can also be interpreted as the trigger for the UE to perform DL positioning measurements on the received DL positioning signal (e.g., periodic DL PRS), in accordance with the DL positioning signal configuration. This may further comprise activating the UE 1 to transmit UL positioning signals in accordance with the UL positioning signal configuration, for reception in at least the access node 141. This may involve triggering the UE to perform the time measurement for positioning signals based on the configuration association, which can be executed via lower layer, such as MAC CE or DCI. This may comprise specific identification of a time gap, or identification of a selection of a time gap reported at 1405. The positioning request may thus serve as a trigger which is separate from the steps of providing the usable configuration to the UE and the access nodes. The positioning request may involve trigger messages from the LMF 160 to one or more access nodes.

At 1411, the UE 1 may apply timing advance (TA) to obtain proper time alignment compensation with regard to propagation delay. The UE may have obtained and/or calculated the required timing information for determining the timing advance.

At 1412, UL-SRS transmission by the UE 1 is indicated, in accordance with the configuration provided.

At 1413, DL-PRS transmission by the access node 141 (and possibly further access nodes) is indicated, in accordance with the PRS configuration.

At 1414, the access node(s) measure RX-TX time difference based on received UL-SRS transmission and paired DL-PRS transmission, according to the configuration association.

At 1415, the UE 1 measures RX-TX time difference based on received DL-PRS configuration and paired UL-SRS transmission, according to the configuration association.

At 1416, corresponding to steps 509 and 510, the LMF 160 obtains measurement reports from the UE 1 and the access node(s) 141.

At step 1417, corresponding to steps 511 and 512, RTT determination is carried out in the positioning node, which may be carried out in accordance with legacy behavior. An estimate of the UE 1 position may be determined, based on the RTT determination.

The proposed solution has been outlined above with reference to the drawings, and by means of various non-limiting examples. Where not clearly contradictory, the features and modes of operation described herein may be combined in any way as set forth in the appended claims.

1. A method carried out in a wireless network for facilitating positioning of User Equipment (UE) based on bi-directional measurement of positioning signals, said method comprising:
configuring first and second resources with mutual configuration association, wherein:
a first configuration is indicative of the first resources for a downlink (DL) positioning signal for transmission by at least one access node of the wireless network,
a second configuration is indicative of the second resources for an uplink (UL) positioning signal for transmission by the UE;
transmitting to the UE, positioning configuration information identifying the configuration association.

2. The method of claim 1, wherein the positioning configuration information is indicative of a timing relation between the first resources and the second resources.

3. The method of claim 1, wherein the positioning configuration information is indicative of a time gap or time offset between the first resources and the second resources.

4. The method of claim 1, wherein the positioning configuration information is indicative of a timing of at least one of said first and second resources.

5. The method of claim 1, wherein the positioning configuration information is indicative of a pairing of one DL positioning signal transmission occasion with at least one UL positioning signal transmission occasion.

6. The method of claim 1, wherein the second resources comprise resources for a plurality of UL positioning signal transmission occasions, wherein the positioning configuration information is indicative of pairing of one DL positioning signal transmission occasion with said plurality of UL positioning signal transmission occasions.

7. The method of claim 1, wherein the positioning configuration information configures the UE to transmit the UL positioning signal according to the second configuration, prior to monitoring for reception of the DL positioning signal in accordance with the identified configuration association.

8. The method of claim 1, comprising:
receiving, from the UE, a signal carrying a measurement report identifying a time of reception in the UE of at least one of the DL positioning signals in relation to the transmission of the UL positioning signal.

9. The method of claim 1, wherein the at least one access node comprises a non-terrestrial node.

10. An access node of a wireless network usable for positioning of User Equipment (UE) based on bi-directional measurement of positioning signals, said access node being configured to:
transmit, to the UE, a first configuration indicative of first resources for an uplink (UL) positioning signal for transmission from the UE;
transmit, to the UE, positioning configuration information to the UE,
wherein the positioning configuration information is indicative of configuration association between the first resources and second resources of a second configuration for a downlink (DL) positioning signal for reception in the UE from the access node.

11. The access node of claim 10, wherein the positioning configuration information is indicative of timing relation between the first resources and the second resources.

12. The access node of claim 10, wherein the positioning configuration information is indicative of a time gap or time offset between the first resources and the second resources.

13. The access node of claim 10, wherein the positioning configuration information is indicative of timing of at least one of said first and second resources.

14. The access node of claim 10, wherein the positioning configuration information is indicative of pairing of one DL positioning signal transmission occasion with at least one UL positioning signal transmission occasion.

15. The access node of claim 10, wherein the first resources comprise resources for a plurality of UL positioning signal transmission occasions, wherein the positioning configuration information is indicative of pairing of one DL, positioning signal transmission occasion with said plurality of UL positioning signal transmission occasions.

16. The access node of claim 10, wherein the positioning configuration information configures the UE to transmit an UL positioning signal according to the first configuration, prior to monitoring for reception of a DL positioning signal, in accordance with the identified configuration association.

17. The access node of claim 10, further configured to:
receive, from the UE, a signal carrying a measurement report identifying time of reception in the UE of at least one DL positioning signals in relation to transmission of an UL positioning signal according to the identified configuration association.

18. The access node of claim 10, wherein the access node comprises a non-terrestrial node.

19. The access node of claim 10, wherein the access node is configured to:
receive a positioning request indicative of positioning with pairing between UL and DL positioning signals.

20. The access node of claim 10, wherein the access node is configured to:
convey an activation signal to the UE, to trigger a positioning procedure with pairing between UL and DL positioning signals.

21-53. (canceled)
